(19) United States
(12) Patent Application Publication
(10) Pub. No.: US 2008/0284727 A1
(43) Pub. Date: Nov. 20, 2008

(54) Input apparatus and information processing apparatus

(75) Inventor: Tadaaki ISHIKAWA, Tsuchiura (JP)

Correspondence Address: Stanley P. Fisher;Reed Smith Hazel & Thomas LLP, Suite 1400, 3110 Fairview Park Drive, Falls Church, VA, 22042-4503, US

(73) Assignee: Hitachi, Ltd.

(21) Appl. No.: 12/149,735

(22) Filed: May 7, 2008

(30) Foreign Application Priority Data
May 16, 2007 (JP) 2007-129994

(51) Int. Cl. G09G 5/00

(52) U.S. Cl. 345/156

(57) ABSTRACT

An input apparatus connected to an information processing apparatus is provided, which includes an input unit to enter a key, a transmission unit to make itself recognized as a keyboard by an operating system (OS) on the information processing apparatus and transmit to the information processing apparatus a key code signal corresponding to the input from the input unit, a receiving unit to receive from the information processing apparatus a signal representing an electrically driven lighting state of the input apparatus, and a control unit to check the signal received from the information processing apparatus and representing the electrically driven lighting state and control transmission of the key code.

### INCORPORATION BY REFERENCE

The present application claims priority from Japanese application JP 2007-129994 filed on May 16, 2007, the content of which is hereby incorporated by reference into this application.

### BACKGROUND OF THE INVENTION

In an information processing apparatus connected to keyboards or input apparatus, similar to the keyboards, that generate key codes, the present invention relates to a method of controlling a stoppage of key code transmission from the input apparatus to the information processing apparatus.

Information processing apparatus such as personal computers have a variety of kinds of input apparatus, such as mouse and game pad. Among them a keyboard is a fundamental input apparatus for entering letters. The keyboard sends to the information processing apparatus a character signal (hereinafter referred to as a key code) corresponding to an individual key switch pressed. Key codes for the same character may have different electric signal waveforms if different keyboards have different connection standards, such as USB and PS2 standards in personal computers. But this difference is absorbed and processed by hardware and OS of the information processing apparatus and the signal is transmitted as an intended character or key input to an application through OS. The application performs a predetermined action according to the character or key input received.

A keyboard normally has three special keys—Num Lock, Caps Lock, Scroll Lock—each having an LED indicator to indicate whether it is on. The on/off of the LED indicator is controlled by an LED lighting state signal transmitted from the OS to the keyboard.

A decision made by the information processing apparatus as to whether the input apparatus is a keyboard depends not on the type of input apparatus but on a signal communicated with the input apparatus. The information processing apparatus recognizes that the input apparatus connected to it is a keyboard by receiving a signal from the input apparatus indicating that the input apparatus is a keyboard. Software running on the OS which defines the input apparatus and establishes communication between the information processing apparatus and the input apparatus is call a device driver. Even a new device whose device driver is not available can be made usable for input and output by describing a relevant device driver. Device drivers for common input apparatus such as keyboard and mouse, on the other hand, are made available on the OS as standard device drivers. So, by performing a signal input/output conforming to the standard device driver, even uncommon input apparatus, such as those with fewer key switches than general keyboards and therefore fewer assignable key codes and those having sensors instead of key switches and adapted to transmit a key code when a particular phenomenon is detected, can also be recognized as keyboards by the information processing apparatus without having to describe a new device driver and install it.

Normally the input apparatus that are recognized as keyboards by the standard device driver are supposed, while they are connected to the information processing apparatus and operational, to act in response to a key switch input or sensor detection and quickly transmit a corresponding key code. Therefore, to intentionally stop a part or all of key code transmissions for the purpose of inspection or prevention of faulty operations, some steps need to be taken. They include disconnecting the input apparatus; changing the operation of the control unit of the input apparatus by a hardware switch to block the key code transmission; temporarily interrupting a hardware connection between key switches or sensors and the control unit of the input apparatus; or canceling the recognition of the input apparatus on the OS.

### SUMMARY OF THE INVENTION

Suppose a part or all of the key code transmissions are intentionally stopped by the method mentioned above. Of the above methods, disconnecting the input apparatus or canceling the recognition of the input apparatus on the OS are simple and reliable. They have a disadvantage that recovering the input apparatus to the state where it can send a key code requires the OS to recognize the input apparatus again, taking time before the original state can be recovered. Another disadvantage is an inability to prevent the transmission of only a part of key codes.

Another method of changing the operation of the control unit of the input apparatus by a hardware switch to block key code transmissions, or temporarily interrupt the hardware connection between the key switches or sensors and the control unit of the input apparatus to limit the key code transmissions also has a problem. That is, although it is possible to limit the transmission of only a part of key codes, an attempt to control the key code transmission limitation from the information processing apparatus side requires a control signal wire in addition to normally needed wires for keyboard signal and electric power, thus losing versatility. Preparing a dedicated device driver indeed enables the transmission of an instruction to the input apparatus via the signal line. But this requires incorporating or installing the dedicated device driver into the OS of the information processing apparatus, degrading versatility or usability.

As a state control signal from the OS on the information processing apparatus to the keyboard, a lighting state signal of an electrically driven indicator, such as LED, defined also in the standard device driver is used. When the LED lighting state output signal matches a predetermined signal pattern, the control unit of the input apparatus that has received the lighting state output signal changes its own operation to limit the transmission of key codes corresponding to a part or all of the key switch inputs or sensor inputs. In returning from the limited state to the normal state, the control unit of the input apparatus similarly checks whether the LED lighting state output signal matches the specified pattern. The transmission of the LED lighting state output signal can also be described by general application development software, so that the lighting state signal transmission can be initiated, interlocked with the state of application software running on the information processing apparatus. Further, if an input apparatus having three special keys—Num Lock, Caps Lock and Scroll Lock—and recognized as a keyboard is connected to the same information processing apparatus, then pressing a special key of this input apparatus to transmit a key code whose LED lighting state needs to be changed causes the information processing apparatus to send a new LED lighting state output signal to all keyboards through the OS. Thus, physically depressing a key of an input apparatus different from an object to be controlled can also control the operation of input apparatus to be controlled.

This invention constitutes an input apparatus that obviates the need to prepare special hardware or install a new device driver in the information processing apparatus, becomes ready for use simply by connecting to the information processing apparatus, as with a commonly used keyboard, and allows application software or other keyboards to limit the transmission of a part or all of key codes. The input apparatus, even while the key code transmissions are limited, remain recognized by the OS on the information processing apparatus. So, there is no need to take trouble to have the input apparatus recognized again before returning to the normal state. With such an input apparatus, it is possible to make various controls during maintenance, such as preventing other keyboards from entering an input and making the keyboards react only to numeral keys depressed when an application software waits for a numerical input, thus improving usability of the information processing apparatus and application software running there.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing configurations of an input apparatus and an information processing apparatus as one embodiment of this invention and a transmission and reception relation among various signals.

FIG. 2 is a flow chart showing an operation of a control unit of the input apparatus in the embodiment of FIG. 1.

FIG. 3 is a ladder diagram showing an example process of signal exchange between the input apparatus and the information processing apparatus in the embodiment of FIG. 1.

FIG. 4 is a schematic diagram showing configurations of an input apparatus and an information processing apparatus as another embodiment of this invention and a transmission and reception relation among various signals.

FIG. 5 is a ladder diagram showing an example process of signal exchange among the input apparatus, the information processing apparatus and an administrator's keyboard in the embodiment of FIG. 1.

### DETAILED DESCRIPTION OF THE EMBODIMENTS

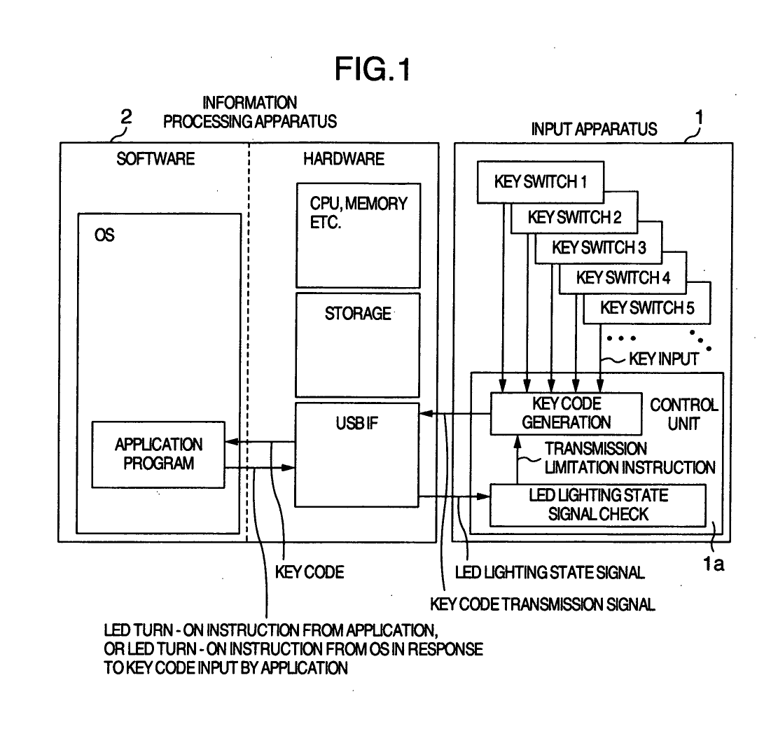

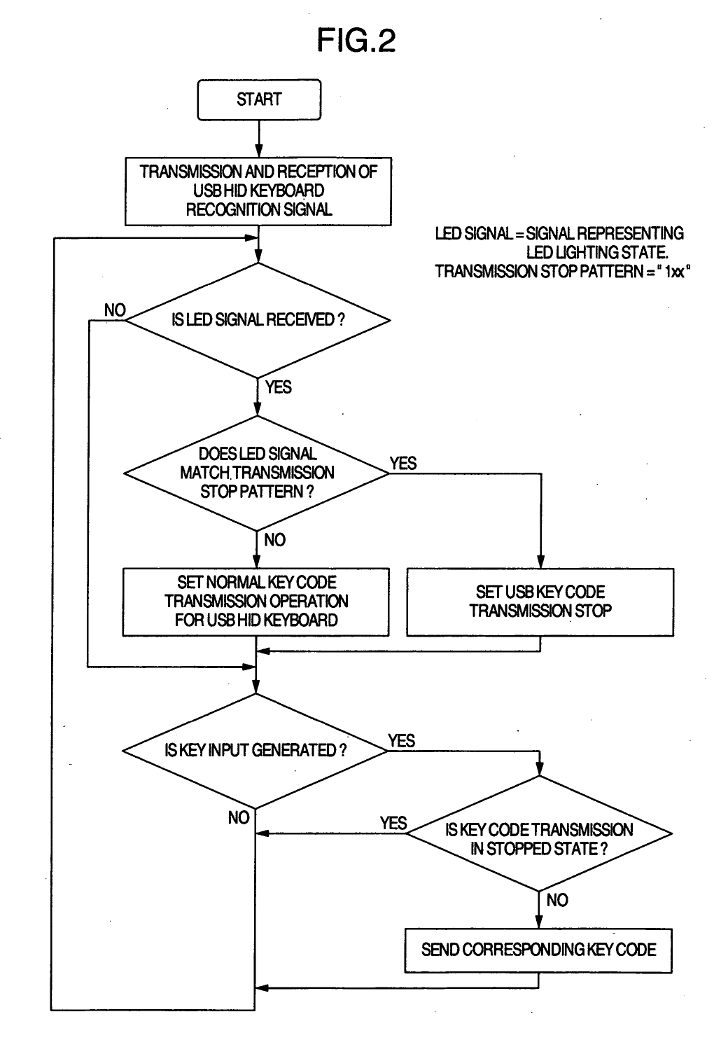

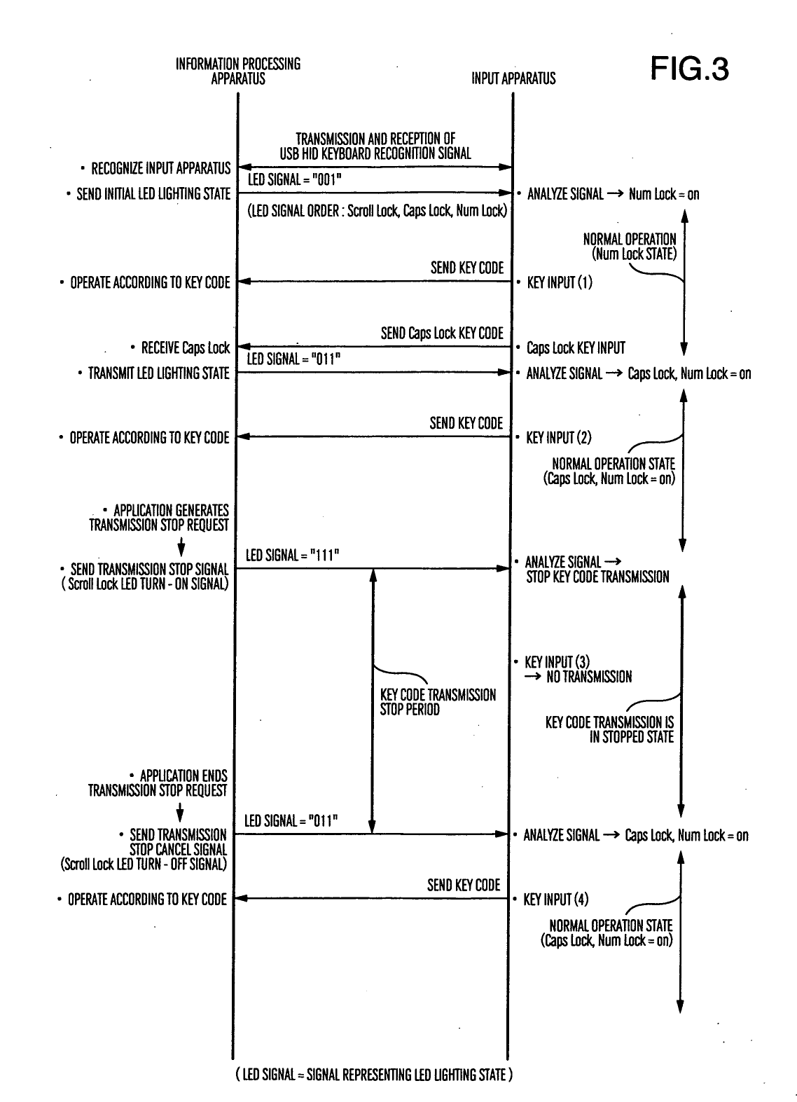

FIG. 1 schematically shows configurations of an input apparatus and an information processing apparatus as one embodiment of this invention and a transmission and reception relation among various signals. FIG. 2 is a flow chart showing an operation of a control unit of the input apparatus. FIG. 3 is a ladder diagram showing an example process of signal exchange between the input apparatus and the information processing apparatus.

In this embodiment, as can be seen from FIG. 1, the input apparatus is USB-connected to the information processing apparatus and is recognized as a HID (Human Interface Device) keyboard by a device driver that comes standard with an operating system (OS). In terms of construction, it has many key switches and a control unit that checks an input signal, i.e., a key input, from individual key switches, generates a key code based on the check result and transmits it. The control unit also has a function to check an LED state signal from the information processing apparatus and stops the transmission of key codes depending on conditions. What a standard device driver for general USB-connected HID keyboards can send from the information processing apparatus to the keyboard is only a signal that represents an on-state of an LED.

The information processing apparatus is contemplated to be a general personal computer (PC) that has a CPU, memory, storage and a USB interface, and, though not shown in the figure, at least one of image output unit for display or monitor, a voice output unit, a digital or analog signal output unit and an interface connecting an input apparatus such as mouse.

As for software, application programs run on a basic operating system (OS). A device driver recognizing the input apparatus as a HID keyboard is incorporated into the OS. In this embodiment, a key code signal transmission function of the input apparatus is controlled by an application program on the OS of the information processing apparatus. The application program directly issues a command for controlling the lighting of keyboard LED or, as in software keyboard, generates a key code input affecting the LED lighting state and sends the LED lighting state signal to the input apparatus through OS and USB interface.

An operation of the key code transmission stop function of the input apparatus is explained by referring to the flow chart of FIG. 2 and the ladder diagram of FIG. 3.

When the input apparatus is connected or started, it performs a series of signal transmission and reception operations for it to be recognized as a HID keyboard by the information processing apparatus. When the input apparatus is recognized as a HID keyboard, the OS of the information processing apparatus sends an initial LED lighting state signal (LED lighting state signal is hereinafter abbreviated an LED signal) to the input apparatus.

The LED signal represents an on-off state of each LED with one bit, with “1” representing an on-state. In this example, the LED signal has 3 bits corresponding to three LEDs—Scroll Lock, Caps Lock and Num Lock—as shown in FIG. 3. In the case of FIG. 3, as the initial LED lighting state only Num Lock is on, so LED signal=“001” is sent to the input apparatus. Upon receiving the LED signal, the input apparatus operates according to an algorithm of FIG. 2. Since a key code transmission stop pattern in this embodiment is an LED signal=“1xx” (x is arbitrary), which means Scroll Lock is lighted, the initial LED signal=“001” causes only the LED representing Num Lock to turn on. That is, the input apparatus simply recognizes that the Num Lock is on and operates accordingly. Thus in response to the next key input (1), the input apparatus sends the corresponding key code to the information processing apparatus.

Next, when there is a Caps Lock key input in the input apparatus, a Caps Lock key code is sent to the information processing apparatus. Upon receiving the Caps Lock key code, the information processing apparatus transmits an LED signal=“011” to the input apparatus to turn on the corresponding LED. The input apparatus analyzes the LED signal received. This LED signal, too, differs from the key code transmission stop pattern, so the input apparatus recognizes that the Caps Lock and Num Lock are on and operates accordingly. Thus, in response to the next key input (2), the input apparatus transmits the corresponding key code.

Next, when a request for the input apparatus to stop the key code transmission occurs on an application program, the application program generates an LED turn-on signal corresponding to Scroll Lock in a way described above and sends an LED signal=“111” as a transmission stop signal to the input apparatus. This signal matches the key code transmission stop pattern=“1xx”, so the input apparatus enters the key code transmission stop state. After this, if any key input occurs (3), the input apparatus does not transmit the corresponding key code.

Next, when the transmission stop request state ends on the application program side, the application program generates an LED turn-off signal corresponding to Scroll Lock in a way similar to that described above and sends an LED signal=“011” as a transmission stop cancel signal to the input apparatus. This signal differs from the transmission stop pattern, so the input apparatus exits the key code transmission stop state, recognizes that the Caps Lock and Num Lock are on and then operates accordingly. Thus, in response to a subsequent key input (4), the input apparatus sends the corresponding key code to the information processing apparatus.

Here, the input apparatus does not need to be shaped like a common keyboard and may be able to send not all alphanumeric characters but only those key codes required by the operation of an application. Thus, there is no need to assign each key code that can be generated to one of individual key switches, but the key codes may be generated for a combination of a plurality of key inputs or for a particular on-off time pattern of key input. The key code transmission limitation may not be applied simultaneously to all key inputs. For example, when an application program requests a numerical key input, the control unit of the input apparatus may be so set that the key code generation is halted for key inputs other than numerical keys and is left active for numerical key inputs. The control unit may then be linked with the application program to prevent characters other than numerical ones from being typed in undesirably.

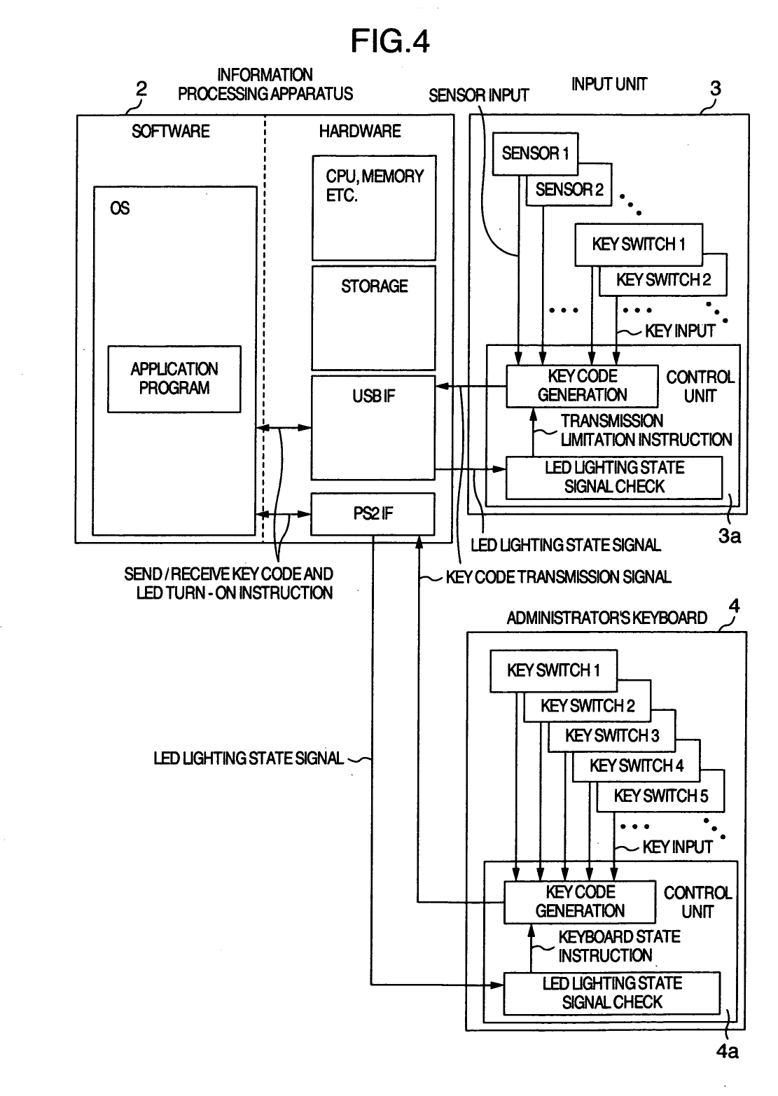

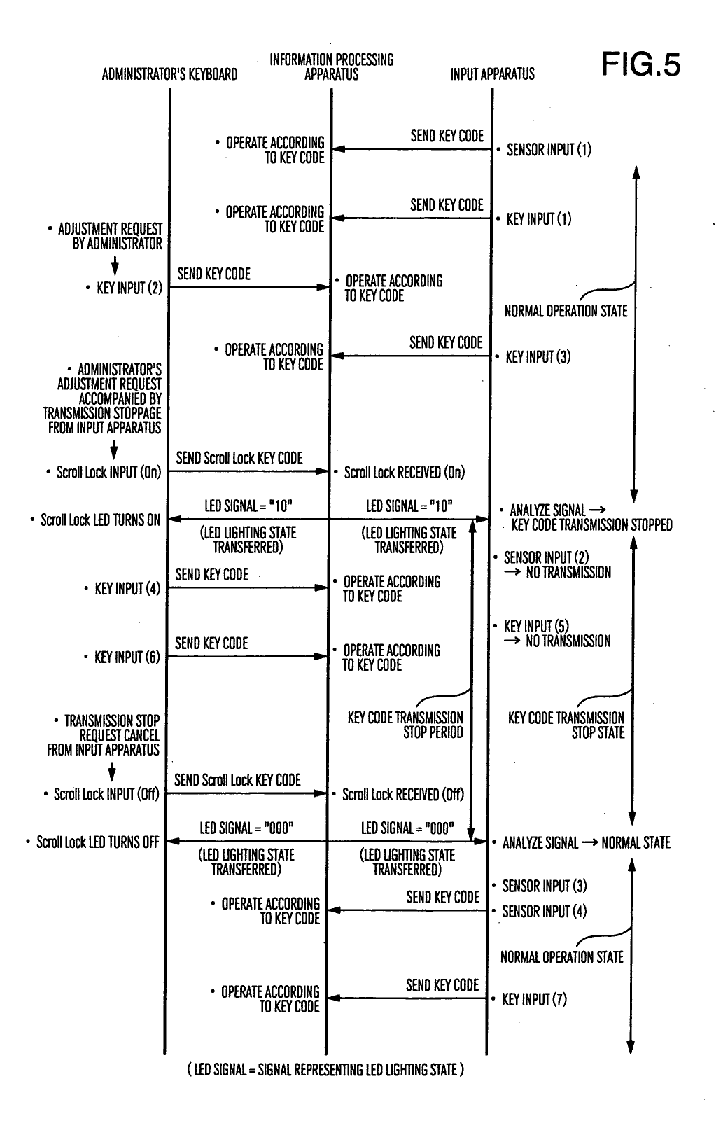

FIG. 4 schematically shows configurations of an input apparatus and an information processing apparatus as another embodiment of this invention and a transmission and reception relation among various signals. FIG. 5 is a ladder diagram showing an example process of signal exchange among the input apparatus, the information processing apparatus and an administrator's keyboard.

In this embodiment, the input apparatus recognized as a USB-connected HID keyboard has not only key switches but also sensors to generate sensor inputs. The control unit of the input apparatus generates key codes not only for key inputs but also for sensor inputs and transmits them. The sensors may be used for various applications, such as contact detection, infrared detection, measurement of distance and sensing of sound. The sensor inputs to the control unit need to be signals that can be processed by the control unit. As for the key code generation for sensor inputs, a key code may be generated for a combination of a plurality of sensor inputs or key inputs and for a particular on-off time pattern of sensor input, as in the case with the key inputs. An issuing of an instruction for stopping the key code transmission depends on whether an LED on-off state signal sent from the information processing apparatus matches a predetermined pattern.

The information processing apparatus is contemplated to be a commonly used personal computer (PC) that has a CPU, memory, storage and a USB interface, and, though not shown in the figure, at least one of image output unit for display or monitor, a voice output unit, a digital or analog signal output unit and an interface connecting an input apparatus such as mouse. As for software, application programs run on a basic operating system (OS). As a keyboard interface beside the USB interface, the information processing apparatus has a relatively popular PS2 interface, to which an administrator's keyboard is connected. In this embodiment, it is assumed that the key code transmission limitation is not implemented by an application program but by an administrator using the administrator's keyboard. The operation of the key code transmission limitation will be explained by referring to FIG. 5. FIG. 5 shows a state in which the initial recognition and setting of the input apparatus is already complete and in which an initial LED on-off state is “000” (Scroll Lock, Caps Lock, Num Lock) with an LED signal pattern instructing the transmission limitation being “1xx”.

In the initial state, the input apparatus is not in the key code transmission limitation state and thus is sending key codes corresponding to a sensor input (1) and a key input (1) to the information processing apparatus. For a key input (2) that the administrator has entered on the administrator's keyboard, too, the corresponding key code is transmitted from the administrator's keyboard to the information processing apparatus. Since this input (2) is not a key code transmission stop signal, subsequent key inputs (3) to the input apparatus result in the corresponding key codes being transmitted to the information processing apparatus.

Then, when a need arises to stop the key code transmission from the input apparatus in order for the administrator to make some adjustments, the administrator presses the Scroll Lock key on the administrator's keyboard. A Scroll Lock key code is sent from the administrator's keyboard to the information processing apparatus. In response to the Scroll Lock getting turned on, the OS on the information processing apparatus side sends to the input apparatus and the administrator's keyboard an LED signal=“100” indicating that the Scroll Lock is on, in order to bring all the keyboards connected to the information processing apparatus into the same state. This function is standard to a particular OS and there is no need to implement additional programming. In the administrator's keyboard, which is a general keyboard, the reception of this LED signal causes the Scroll Lock LED to turn on.

On the input apparatus side, on the other hand, since this LED turn-on signal matches “1xx”, the pattern instructing the key code transmission limitation, the input apparatus enters the key code transmission stop state. During the key code transmission stop state, no key codes are generated or transmitted in response to sensor input (2) or key input (5) to the input apparatus. The administrator's keyboard has no transmission limitation function and thus, during this state, continues to generate key codes corresponding to the key inputs (4) and (6) and send them to the information processing apparatus. In this way the administrator is able to make adjustments on the information processing apparatus from the administrator's keyboard, without being annoyed by the key code transmission from the input apparatus.

After the adjustments are made, the administrator enters a Scroll Lock key input on the administrator's keyboard to make the input apparatus active again, causing the Scroll Lock key code to be transmitted from the administrator's keyboard to the information processing apparatus in the same way as mentioned earlier. In response to the Scroll Lock turning off, the OS on the information processing apparatus side sends to the input apparatus and the administrator's keyboard an LED signal=“000” indicating that the Scroll Lock is off, in order to bring all the keyboards connected to the information processing apparatus into the same state. When the administrator's keyboard receives this signal, its Scroll Lock LED turns off. On the input apparatus side, since this LED turn-on signal does not match “1xx”, the pattern instructing the key code transmission limitation, the input apparatus exits the key code transmission stop state. After this, the key code transmission corresponding to two sensor inputs (3) and (4) and the key code transmission corresponding to a key input (7) become possible.

Providing an administrator with an administrator's keyboard and allowing general users to use input apparatus, as described above, offers an advantage of being able to permit the administrator to immediately stop transmission from the input apparatus in the event that an inconvenience occurs and to make adjustments on the information processing apparatus using the administrator's keyboard.

Although this embodiment assumes that the administrator's keyboard is a general keyboard, the only requirement is that the administrator's keyboard have minimum required key switches, as with the input apparatus. Further, although this embodiment uses “1xx”, which indicates that the Scroll Lock LED is turned on, as the pattern to instruct the key code transmission limitation, other patterns may also be used as long as they do not pose any problem to the operation of application programs. Possible patterns may include “0xx”, which represents the Scroll Lock LED being turned off, and further include Caps Lock and Num Lock LED signals or a combination of these. It is also possible to set the control unit of the input apparatus to change according to the signal pattern a combination of key or sensor inputs that instructs the transmission limitation. Further, while this embodiment uses LED lighting, the only requirement is that a means be provided which electrically produces an indication visible to the user.

It should be further understood by those skilled in the art that although the foregoing description has been made on embodiments of the invention, the invention is not limited thereto and various changes and modifications may be made without departing from the spirit of the invention and the scope of the appended claims.

1. An input apparatus connected to an information processing apparatus, comprising:
an input unit which enters a key;
a transmission unit which makes itself recognized as a keyboard by an operating system (OS) on the information processing apparatus and transmits to the information processing apparatus a key code signal corresponding to an input from the input unit;
a receiving unit which receives from the information processing apparatus a signal representing an electrically driven lighting state of the input apparatus; and
a control unit which checks the signal received from the information processing apparatus and representing the electrically driven lighting-state and control transmission of the key code.

2. An input apparatus according to claim 1, wherein the electrically driven lighting is done by an LED turning on.

3. An input apparatus according to claim 1, wherein the control unit checks a signal received from the information processing apparatus and representing the electrically driven lighting state and stops at least a part of the key code signal transmissions.

4. An input apparatus according to claim 1, wherein the control unit checks a signal received from the information processing apparatus and representing the electrically driven lighting state and cancels the stop of the key code signal transmissions.

5. An input apparatus according to claim 1, being recognized by software that comes standard with the operating system on the information processing apparatus.

6. An input apparatus according to claim 1, wherein the input unit further has a unit which enters a sensor input;
wherein the transmission unit sends to the information processing apparatus a key code signal corresponding to the sensor input from the input unit

7. An information processing system having an information processing apparatus connected with an input apparatus,
wherein the input apparatus comprises:
an input unit which enters a key;
a transmission unit which makes itself recognized as a keyboard by an operating system (OS) on the information processing apparatus and transmits to the information processing apparatus a key code signal corresponding to an input from the input unit;
a receiving unit which receives from the information processing apparatus a signal representing an electrically driven lighting state of the input apparatus; and
a control unit which checks the signal received from the information processing apparatus and representing the electrically driven lighting state and control transmission of the key code;
wherein the information processing apparatus comprises:
an operating system (OS); and
an application program which causes the OS to receive the key code signal from the input apparatus and transmit a signal representing the electrically driven lighting state of the input apparatus.

8. An information processing system according to claim 7, wherein the information processing apparatus has a plurality of input apparatus;
wherein a key code signal transmitted from a first input apparatus of the plurality of the input apparatus is used to control transmission of a key code signal from a second input apparatus different from the first input apparatus.
